(19) United States
(12) Patent Application Publication
(10) Pub. No.: US 2022/0036542 A1
(43) Pub. Date: Feb. 3, 2022

(54) DEEP LEARNING MODELS USING LOCALLY AND GLOBALLY ANNOTATED TRAINING IMAGES

(71) Applicant: International Business Machines Corporation, Armonk, NY (US)

(72) Inventors: Maria Victoria Sainz de Cea, Somerville, MA (US); David Richmond, Newton, MA (US)

(21) Appl. No.: 16/940,695

(22) Filed: Jul. 28, 2020

(51) Int. Cl. G06T 7/00; G06K 9/62; G06N 3/08; G06N 3/04

(52) U.S. Cl. CPC G06T 7/0012; G06K 9/628; G06N 3/04; G06N 3/08; G06K 9/6256

(57) ABSTRACT

A method for training an artificial intelligence (AI) system for improved health screening is provided. A processor of the AI system, where the AI system may include a combined AI model comprising one or more AI models, may receive training images. The processor may utilize, one or more AI models that each analyze the training images. The one or more AI models may include respective objective functions. The processor may receive, from the one or more AI models, the respective objective functions obtained after each of the one or more AI models are separately trained. The method my further involve submitted a combined weighted objective function to train the AI system. The combined weighted objective function may be a weighted combination of the respective objective function from each of the one or more AI models.

### BACKGROUND

The present disclosure relates generally to the field of medical imaging, and more specifically to providing improved health screenings by utilizing artificial intelligence models trained using locally and globally annotated training images.

Use of deep learning for automatically classifying mammogram images as malignant or cancer free has become increasingly popular due to its proven success. When radiologists assess mammography images, they focus on the appearance of certain local lesions (e.g., masses, groups of microcalcification, etc.) that may be a sign of breast cancer. When scanning a mammography to look for breast cancer, for example, the size of the lesion that determines whether the image corresponds to a benign or malignant case may only take as little as 1% of the whole breast region. Therefore there is a need for neural networks which focus on the areas of the lesion to determine whether the lesion is benign or malignant. Obtaining local annotations from health care practitioners is expensive and not always possible, which results in a significant reduction in the number of samples available to training algorithms that require local information and thus a reduction in the sensitivity and/or specificity of the algorithms.

### SUMMARY

Embodiments of the present disclosure include a method, computer program product, and system for utilizing artificial intelligence models trained using locally and globally annotated training images.

In some embodiments, a method for training an artificial intelligence (AI) system for improved health screening is provided. In some embodiments, a processor of the AI system, where the AI system may include a combined AI model comprising one or more AI models, may receive training images. In some embodiments, the processor may utilize, one or more AI models that each analyze the training images. In some embodiments, the one or more AI models may include respective objective functions. In some embodiments, the processor may receive, from the one or more AI models, the respective objective functions obtained after each of the one or more AI models are separately trained. In some embodiments, the processor may submit a combined weighted objective function to train the AI system. In some embodiments, the combined weighted objective function may be a weighted combination of the respective objective function from each of the one or more AI models.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram of an exemplary system for improved health screening using artificial intelligence, in accordance with aspects of the present disclosure.

FIG. 2 is a flowchart of an exemplary method for improved health screening using artificial intelligence, in accordance with aspects of the present disclosure.

FIG. 3A illustrates a cloud computing environment, in accordance with aspects of the present disclosure.

FIG. 3B illustrates abstraction model layers, in accordance with aspects of the present disclosure.

FIG. 4 illustrates a high-level block diagram of an example computer system that may be used in implementing one or more of the methods, tools, and modules, and any related functions, described herein, in accordance with aspects of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of medical imaging, and more specifically to providing improved health screenings by utilizing artificial intelligence models trained using locally and globally annotated training images. While the present disclosure is not necessarily limited to such applications, various aspects of the disclosure may be appreciated through a discussion of various examples using this context.

Use of deep learning for automatically classifying mammogram images as malignant or cancer free has become increasingly popular due to its proven success. When radiologists assess mammography images, they focus on the appearance of certain local lesions (e.g., masses, groups of microcalcification, etc.) that may be a sign of breast cancer. When scanning a mammography to look for breast cancer, for example, the size of the lesion that determines whether the image corresponds to a benign or malignant case may only take as little as 1% of the whole breast region. Therefore there is a need for neural networks which focus on the areas of the lesion to determine whether the lesion is benign or malignant. Obtaining local annotations from health care practitioners is expensive and not always possible, which results in a significant reduction in the number of samples available to training algorithms that require local information and thus a reduction in the sensitivity and/or specificity of the algorithms. The present disclosure expands the training image sets which can be used to train an AI model to provide local annotations by creating a complex AI model which utilizes a combined loss function for training where the combined loss function includes loss functions from a classification AI model, an attention map AI output, and a localization AI model.

In some embodiments, a method for training an artificial intelligence (AI) system for improved health screening is provided. In some embodiments, a processor of the AI system may receive training images. The training images may be medical images taken from patients whose medical histories are known. The training images may be globally annotated to indicate whether the patient from whom the medical image was taken was diagnosed with a medical condition, which may be reflected in the medical image.

For example, one of the training images may be a mammogram of a left breast from a patient who was diagnosed with breast cancer in the left breast. This medical image may be globally annotated to indicate that the medical image is associated with a positive breast cancer diagnosis. As another example, a medical image of the right breast from the same patient, whose screening exams and/or other subsequent diagnostic exams indicate that the patient does not have cancer in the right breast, may be globally annotated to indicate that the medical image is associated with a negative breast cancer diagnosis.

In some embodiments, the training images may be locally annotated to identify regions of the medical images which warrant further review for purposes of diagnosing the patient. In some embodiments the medical images are locally annotated by health care practitioners who reviewed the medical images for the identified portions. For example, a medical image may include hand drawn circles around certain features in the medical image that a health care practitioner identified a lesion, and which may require further review by other health care practitioners to determine whether the identified region of the medical image indicates that the patient requires additional screening or diagnostic care.

In some embodiments, some of the training images may have global annotations. In some embodiments, some of the training images may have local annotations. In some embodiments, the training images may be medical images that reveal internal structures of the body hidden by the skin. The training images may be radiological images generated through imaging technologies, such as X-ray radiography, magnetic resonance imaging, ultrasound, endoscopy, elastography, tactile imaging, thermography, medical photography, and/or nuclear medicine functional imaging techniques, such as, positron emission tomography (PET) and single-photon emission computed tomography (SPECT). In some embodiments, the training images may be digital X-rays. In some embodiments, the trainings images may be mammograms.

In some embodiments, the processor of the AI system may utilize a combined AI model having one or more AI models that each analyze the training images. In some embodiments, the one or more AI models may be designed for different purposes. In some embodiments, a first AI model may be designed for classification purposes to determine a probability that an object in the image belongs to a particular class of objects, for example, to classify images as indicating that the person from whom the image was taken likely has a medical condition or likely does not have the medical condition.

In some embodiments, a second AI model may be designed for object detection to identify objects of interest (e.g., lesions, masses, calcifications, asymmetry or architectural distortion) in the images and localize them (e.g., identify/locate/distinguish/etc. the objects of interest by, for example, providing markings (e.g., drawing a box around the objects or shading the objects of interest) around the objects of interest). In some embodiments, the one or more AI models may include respective objective functions, and the objective functions may be utilized to train the artificial intelligence models to perform their functions. As an example, the one or more AI models may involve optimization algorithms. Continuing the example, the one or more AI models may be deep learning neural networks trained using stochastic gradient descent optimization algorithms.

In some embodiments, the objective functions for the AI models may be loss functions that are used as part of the optimization process to determine the error for the current state of a model, repeatedly, as the model is trained. For example, the loss function for the first AI model designed/generated for classification may be used to calculate a penalty for an incorrect classification. The loss function for the second AI model designed to localize objects of interest may be used to calculate a penalty for an incorrect identification and marking of objects of interest.

In some embodiments, as described herein, the method(s) for improved health screenings may further involve the processor receiving, from the one or more AI models, respective objective functions after each of the one or more AI models are separately trained. For example, the first AI model may be trained using training images to classify images as indicating that the person from whom the image was taken likely does have a medical condition or likely does not have the medical condition. During the training process, an objective function may be used as part of the optimization process for the first AI model to determine the error for the current state of the model, repeatedly, as the first AI model is trained.

In some embodiments, once the weights associated with the first AI model are adjusted such that the error of the model is minimized, the objective function of the first AI model may be received by the AI system. Similarly, the second AI model may be trained to identify objects of interest (e.g., lesions) in the images and localize them. During the training process, an objective function may be used as part of the optimization process for the second AI model to determine the error for the current state of the model, repeatedly (e.g., continuously, cyclically, etc.), as the second AI model is trained. Once the weights associated with the second AI model are adjusted such that the error of the model is minimized, the objective function of the second AI model may be received by the AI system. As an example, the error for the AI models may be a way to check the predictions of the fully connected layers against the actual values with a goal of minimizing the difference between the predictions and the real values as much as possible (e.g., by adjusting the weights in both the convolutional and fully-connected layers).

In some embodiments, the method for improved health screenings described herein may further involve the processor utilizing a combined weighted objective function to train the AI system, wherein the combined weighted objective function is a weighted combination of the respective objective function from each of the one or more AI models. For example, the AI system may be trained by inputting training images and utilizing the combined weighted objective function to calculate the error of the current state of the AI system, repeatedly, until the error is minimized. In some embodiments, the combined weighted objective function may be the weighted sum of the objective function for the first AI model, with variable inputs reflecting the state of the first AI model after it was trained, and the objective function for the second AI model, with variable inputs reflecting the state of the second AI model after it was trained.

In some embodiments, the combined weighted objective function may include a first scalar multiplier for the objective function of the first AI model and a second scalar multiplier for the objective function of the second AI model. In some embodiments, the first and second scalar multipliers may be determined by trial and error to determine the values of the scalar multipliers, which result in a greater/greatest accuracy in the predictions generated for/by the AI system (e.g., classifying an image as indicating that a patient likely has a medical condition or that a patient likely does not have a medical condition and localizing objects of interest in the image).

In some embodiments, after training the AI system utilizing the combined weighted objective function to minimize the error of the AI system, the AI system may be used by inputting one or more medical images into a combined AI model, which combines classification and localization tasks, receiving a classification indicating that the person from whom the one or more medical image was taken likely has a medical condition or likely does not have the medical condition, and receiving an output which localizes objects of interest (e.g., lesions) in the images (e.g., the one or more medical image may be output with objects of interest annotated with boxes around them).

In some embodiments, the one or more AI models may include classification AI criteria, where the classification AI criteria are used to classify whether a first image of the training images indicates that a user, from whom the first image was taken, likely has cancer or that the user is likely cancer-free. The classification AI criteria (e.g., classification AI model) may be any AI model utilized to perform classification tasks, including GoogLeNet, VGG, ResNet, and Inception. In some embodiments, the classification AI criteria may utilize a convolutional neural network (“CNN”) architecture. In some embodiments, the objective functions may include a classification loss function. A classification loss function may be any loss function utilized when training deep learning models used for classification purposes. For example, the classification loss function may be a cross-entropy function or a mean squared error function.

In some embodiments, the one or more AI models may include attention map AI criteria, where the attention map AI criteria are used to generate attention maps. In some embodiments, the attention maps are representations of areas of the training images that the classification AI criteria relied on to make a classification. For example, if the classification AI criteria utilized 10 pixels of a training image to classify the training image as indicating that a user likely has cancer (e.g., based on lesions in those areas of the image), then the 10 pixels may be identified in an attention map generated by the attention map AI criteria (for example, by shading the 10 pixels with a background color).

In some embodiments, the attention map AI criteria (e.g., attention map AI model) may utilize a convolutional neural network (“CNN”) architecture. In some embodiments, the respective objective functions may include an attention loss function. For example, the attention loss function may be related to the classification branch and may utilize the attention maps for the classification branch (which may be solved separately). The attention loss function may try to make the attention of the classification network centered around an annotated area of interest (such as a lesion). The attention loss function may be any loss function utilized in training deep learning models to generate attention maps, including, for example, pixel-wise cross-entropy. In some embodiments, the attention loss function may be the dice coefficient defined as a loss function.

In some embodiments, the one or more AI models may include localization AI criteria, where the localization AI criteria may be used to localize objects of interest on the first image of the training images. For example, the localization AI criteria may identify objects of interest in the first image by generating an output image which identifies the objects of interest by drawing a box around them. For example, the object of interest may be lesions in a medical image which may provide an indication that the person from whom the image was taken likely has cancer. The localization AI criteria (e.g., localization AI model) may be any deep learning model utilized for localization tasks, including RetinaNet, EfficientDet, SSD, and Faster R-CNN. In some embodiments, the localization AI criteria may utilize a convolutional neural network architecture. The localization loss function may only be used when the training image input into the AI system has local annotations.

In some embodiments, the respective objective functions may include a localization loss function. The localization loss function may try to make the localizations output by the localization AI criteria identifying objects of interest in the first image. For example, the localization loss function may be any loss functions used to train deep learning models to perform localization tasks, including a combination of regression loss for object localization and focal loss for object classification. In some embodiments, the localization loss function may be the dice coefficient defined as a loss function.

In some embodiments, the combined weighted objective function may be a weighted sum of the classification loss function, attention loss function, and localization loss function. In some embodiments, in the combined weighted objective function, the classification loss function may be multiplied by a first scalar multiplier, and the localization loss function may be multiplied by a second scalar multiplier, and the attention loss function may be multiplied by a third scalar multiplier. The first, second, and third scalar multipliers may be values which result in the most accurate training of the AI system to perform its combined tasks of classification (e.g., whether an image indicates that the person from whom the image was taken likely has cancer), generating an attention map (e.g., representations of areas of the training images that the classification AI criteria utilized to make a classification), and providing localization (e.g., identify and localize objects of interest in a medical image). The first, second, and third scalar multiplier may be determined manually or by a computer by trial and error (e.g., testing possible values [using a random, or pseudo-random, number generator] to determine which values produce the most accurate results).

In some embodiments, the one or more AI models may be deep learning models utilizing a convolutional neural network architecture. In some embodiments, the one or more AI models may utilize a first set of common layers. For example, the first AI model and the second AI model may both be convolutional neural networks where the first AI model is designed to classify whether a first image of the training images indicates that a user likely has cancer or that a user is likely cancer-free and the second AI model is designed to localize objects of interest in/on the first image. A set of initial layers of the convolutional neural network may be common to both AI models. In some embodiments, the two models may be trained using hard parameter sharing where the two models explicitly share parameters. In some embodiments, the two models may be trained using soft parameter sharing, where the models are separate and are regularized to encourage the parameters of the shared layers to be similar.

As another example, the first AI model may be designed to classify whether a first image of the training images indicates that a user likely has cancer or that a user is likely cancer-free and the second AI model may be designed to generate attention maps (e.g., representations of areas of the training images that the classification AI criteria utilized to make a classification). A set of initial layers of the convolutional neural network may be common to both AI models. Additionally, the second AI model may also utilize the same layers of the first model used to make a classification (e.g., connected and fully connected layers in a convolutional neural network) to generate the attention map. In some embodiments, the two models may be trained using hard parameter sharing where the two models explicitly share parameters. In some embodiments, the two models may be trained using soft parameter sharing, where the models are separate and are regularized to encourage the parameters of the shared layers to be similar.

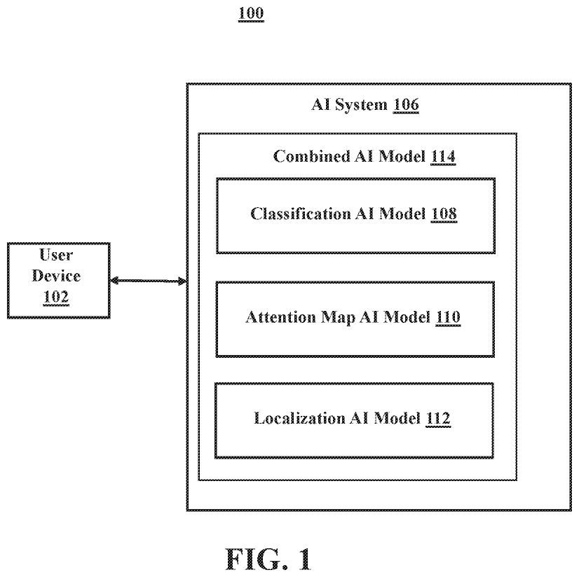

Referring now to FIG. 1, a block diagram of a network 100 to improve health screenings using AI is illustrated. Network 100 includes a user device 102 and an AI system 106 which are configured to be in communication with each other. In some embodiments, first device 102 may be any device that contains a processor configured to perform one or more of the functions or steps described herein this disclosure. AI system 106 includes a classification AI criteria/model 108, an attention map AI criteria/model 110, and a localization AI criteria/model 112.

In some embodiments, AI system 106 has been trained to improve health screenings. In some embodiments, the classification AI criteria/model 108 has been trained using labeled training images to classify whether a first image of the training images indicates that a user likely has cancer or that the user is likely cancer-free. In some embodiments, the attention map AI criteria/model 110 has been trained using labeled training images to generate attention maps. In some embodiments, the attention maps are representations of areas of the training images that the classification AI criteria/model 110 utilized to make a classification. In some embodiments, the localization AI criteria/model 112 has been trained using labeled training images to localize objects of interest in the first image. In some embodiments, after each of the classification AI criteria/model 108, attention map AI criteria/model 110, and localization AI criteria/model 108 has been separately trained, the AI system 106 receives a classification loss function, an attention loss function, and a localization loss function, respectively, from the AI models. A combined weighted objective function, which is a weighted sum of the loss functions from each AI model, is then used to train a combined AI model 114 which includes classification branches, localization branches, and an attention map branch which bifurcates from the classification branch after the layers of the classification branch which are used to make a classification (e.g., connected and fully connected layers of a convolutional neural network).

In some embodiments, a user inputs a user image into the user device 102 which is in communication with the AI system 106. In some embodiments, the AI system 106 receives the user image, inputs the user image into the combined AI model 114 and subsequently receives a classification, attention map, and localization output from the combined AI model 114 that was trained on the models 108-112, and which the AI system 106 then communicates (e.g., pushes, forwards, etc.) to the user device 102.

It is noted that the AI system 106 illustrated in FIG. 1 utilizes a complex loss function that combines both local information (e.g., annotated masses, calcifications, architectural distortions, asymmetries, etc.) and global information (e.g., patient cancer diagnoses) to force the classification network class activation map to be positioned around the lesion under consideration and jointly learn global output (e.g., cancer or cancer-free) and lesion localization with multitask learning. In some embodiments, the AI system 106 is trained with three different losses that are be combined in a complex loss function that captures local information (e.g., benign and malignant lesion location) and global information (e.g., whether the mammogram image corresponds to a patient with cancer or not). In some embodiments, the first layers of the network are common for both classification and localization. Afterwards, two branches are added to the first set of common layers: one that outputs a single label for the image (e.g., cancer/cancer free) and one that outputs a heatmap around the lesion; each of these branches yield to a different loss.

In some embodiments, the AI system 106 illustrated in FIG. 1 may be used to classify screening mammography and determine whether a patient needs further evaluation or is cancer free. For instance, the AI system 106 has several functionalities which are ultimately included to improve the classification performance through local information, but may also be used independently. When a new mammogram (e.g., never seen by the AI system 106) arrives to the pipeline, the image is classified using the classification branch as cancer or cancer-free, making the network 100 an autonomous reader.

In addition, the AI system 106 provides an attention map that highlights the areas that made the algorithm make the decision and a heatmap. In this case, the algorithm can be used to assist a radiologist in her decision and speed up the radiologist's decision. The presence of the attention map may potentially highlight missed lesions. The output of the localization branch will highlight potential regions with lesions in the image. The existence of this localization map may also allow the use of the AI system 106 as a Computer Aided Detection (CAD) mechanism. It is noted that due to the AI system 106 described herein having a segmentation map, regions with lesions in the breast can be used for measuring the size, shape, or intensity of masses, microcalcification clusters, etc. and assessing a temporal evolution of lesions if prior images are available.

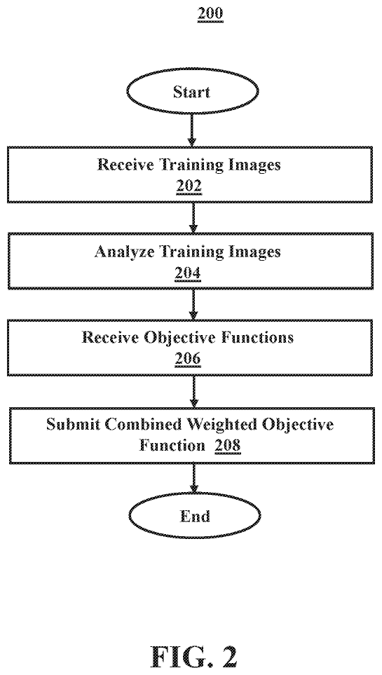

Referring now to FIG. 2, illustrated is a flowchart of an exemplary method 200 for improving health screening using artificial intelligence, in accordance with embodiments of the present disclosure. In some embodiments, a processor of a system (e.g., an AI system) may perform the operations of the method 200. In some embodiments, method 200 begins at operation 202. At operation 202, the AI system receives training images. In some embodiments, method 200 proceeds to operation 204, where the AI system utilizes one or more AI models that each analyze the training images. In some embodiments, the one or more AI models each include respective objective functions. In some embodiments, method 200 proceeds to operation 206. At operation 206, the AI system receives, from the one or more AI models, respective objective functions obtained after each of the one or more AI models are separately trained. In some embodiments, method 200 proceeds to operation 208. At operation 208, the AI system submits a combined weighted objective function to train the AI system. In some embodiments, the combined weighted objective function is a weighted combination of the respective objective function from each of the one or more AI models.

As discussed in more detail herein, it is contemplated that some or all of the operations of the method 200 may be performed in alternative orders or may not be performed at all; furthermore, multiple operations may occur at the same time or as an internal part of a larger process.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

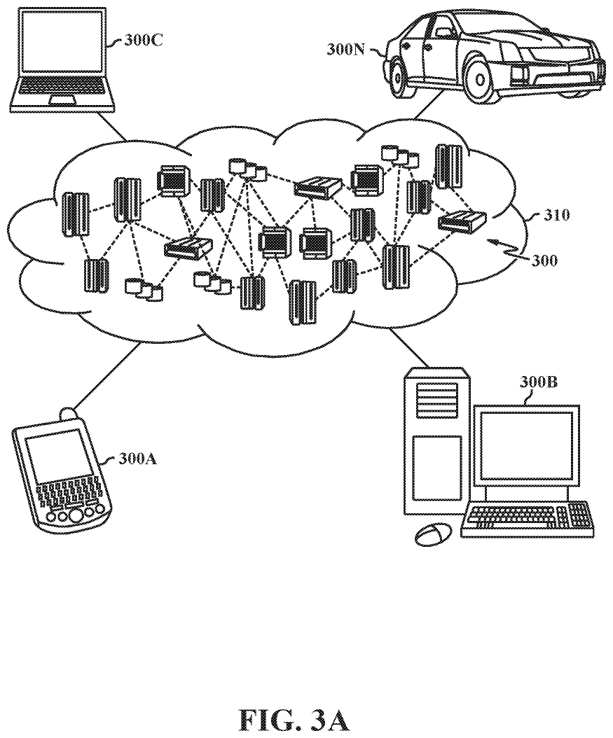

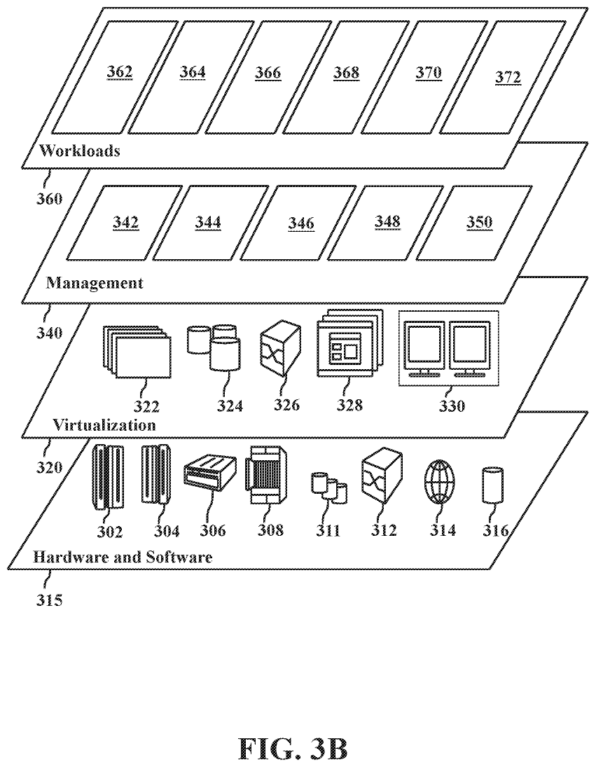

FIG. 3A, illustrated is a cloud computing environment 310 is depicted. As shown, cloud computing environment 310 includes one or more cloud computing nodes 300 with which local computing devices used by cloud consumers, such as, for example, personal digital assistant (PDA) or cellular telephone 300A, desktop computer 300B, laptop computer 300C, and/or automobile computer system 300N may communicate. Nodes 300 may communicate with one another. They may be grouped (not shown) physically or virtually, in one or more networks, such as Private, Community, Public, or Hybrid clouds as described hereinabove, or a combination thereof.

This allows cloud computing environment 310 to offer infrastructure, platforms and/or software as services for which a cloud consumer does not need to maintain resources on a local computing device. It is understood that the types of computing devices 300A-N shown in FIG. 3A are intended to be illustrative only and that computing nodes 300 and cloud computing environment 310 can communicate with any type of computerized device over any type of network and/or network addressable connection (e.g., using a web browser).

FIG. 3B, illustrated is a set of functional abstraction layers provided by cloud computing environment 310 (FIG. 3A) is shown. It should be understood in advance that the components, layers, and functions shown in FIG. 3B are intended to be illustrative only and embodiments of the disclosure are not limited thereto. As depicted below, the following layers and corresponding functions are provided.

Hardware and software layer 315 includes hardware and software components. Examples of hardware components include: mainframes 302; RISC (Reduced Instruction Set Computer) architecture based servers 304; servers 306; blade servers 308; storage devices 311; and networks and networking components 312. In some embodiments, software components include network application server software 314 and database software 316.

Virtualization layer 320 provides an abstraction layer from which the following examples of virtual entities may be provided: virtual servers 322; virtual storage 324; virtual networks 326, including virtual private networks; virtual applications and operating systems 328; and virtual clients 330.

In one example, management layer 340 may provide the functions described below. Resource provisioning 342 provides dynamic procurement of computing resources and other resources that are utilized to perform tasks within the cloud computing environment. Metering and Pricing 344 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 346 provides access to the cloud computing environment for consumers and system administrators. Service level management 348 provides cloud computing resource allocation and management such that required service levels are met. Service Level Agreement (SLA) planning and fulfillment 350 provide pre-arrangement for, and procurement of, cloud computing resources for which a future requirement is anticipated in accordance with an SLA.

Workloads layer 360 provides examples of functionality for which the cloud computing environment may be utilized. Examples of workloads and functions which may be provided from this layer include: mapping and navigation 362; software development and lifecycle management 364; virtual classroom education delivery 366; data analytics processing 368; transaction processing 370; and improved health screening using AI 372.

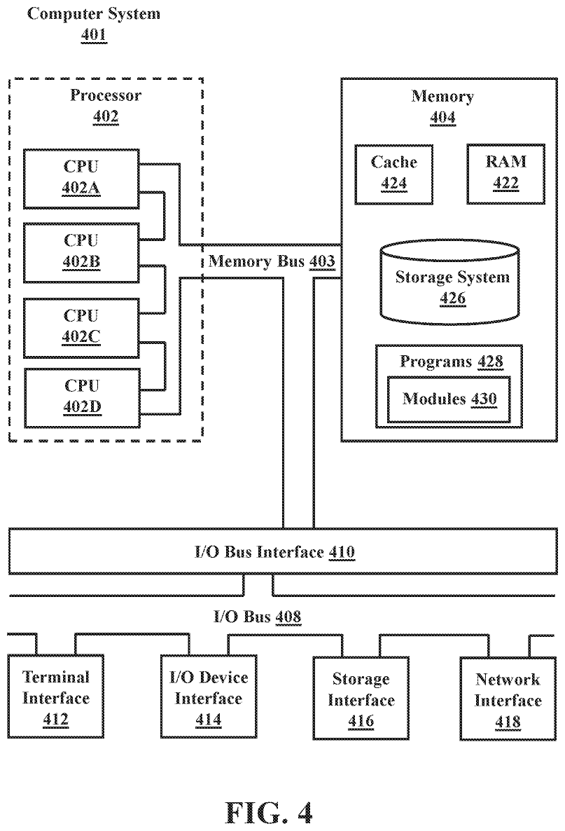

FIG. 4, illustrated is a high-level block diagram of an example computer system 401 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 401 may comprise one or more CPUs 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A method for training an artificial intelligence (AI) system for improved health screening, the method comprising:
receiving, by the AI system, training images, wherein the AI system includes a combined AI model comprising one or more AI models;
utilizing, by the AI system, one or more AI models that each analyze the training images, wherein the one or more AI models include respective objective functions;
receiving, from the one or more AI models, the respective objective functions obtained after each of the one or more AI models are separately trained; and
submitting a combined weighted objective function to train the AI system, wherein the combined weighted objective function is a weighted combination of the respective objective functions from each of the one or more AI models.

2. The method of claim 1, wherein the one or more AI models include classification AI criteria, wherein the classification AI criteria are used to classify whether a first image of the training images indicates that a user likely has cancer or that the user is likely cancer-free.

3. The method of claim 2, wherein the respective objective functions include a classification loss function.

4. The method of claim 3, wherein the one or more AI models include attention map AI criteria, wherein the attention map AI criteria are used to generate attention maps, wherein the attention maps are representations of areas of the training images that the classification AI criteria utilized to make a classification.

5. The method of claim 4, wherein the respective objective functions include an attention loss function.

6. The method of claim 5, wherein the one or more AI models include localization AI criteria, wherein the localization AI criteria are used to localize objects of interest on the first image.

7. The method of claim 6, wherein the respective objective functions include a localization loss function.

8. The method of claim 1, wherein the one or more AI models are deep learning models utilizing a convolutional neural network architecture.

9. The method of claim 1, wherein the one or more AI models utilize a first set of common layers.

10. A system comprising:
a memory; and
a processor in communication with the memory, the processor being configured to perform operations comprising:
receiving training images;
utilizing one or more AI models that each analyze the training images, wherein the one or more AI models include respective objective functions;
receiving, from the one or more AI models, the respective objective functions obtained after each of the one or more AI models are separately trained; and
submitting a combined weighted objective function to train the AI system, wherein the combined weighted objective function is a weighted combination of the respective objective function from each of the one or more AI models.

11. The system of claim 10, wherein the one or more AI models include classification AI criteria, wherein the classification AI criteria are used to classify whether a first image of the training images indicates that a user likely has cancer or that the user is likely cancer-free.

12. The system of claim 11, wherein the respective objective functions include a classification loss function.

13. The system of claim 12, wherein the one or more AI models include attention map AI criteria, wherein the attention map AI criteria are used to generate attention maps, wherein the attention maps are representations of areas of the training images that the classification AI criteria utilized to make a classification.

14. The system of claim 13, wherein the respective objective functions include an attention loss function.

15. The system of claim 14, wherein the one or more AI models include localization AI criteria, wherein the localization AI criteria are used to localize objects of interest on the first image.

16. The system of claim 15, wherein the respective objective functions include a localization loss function.

17. The system of claim 16, wherein the one or more AI models are deep learning models utilizing a convolutional neural network architecture.

18. The system of claim 17, wherein the one or more AI models utilize a first set of common layers.

19. A computer program product comprising a computer readable storage medium having program instructions embodied therewith, the program instructions executable by a processor to cause the processor to perform operations, the operations comprising:
receiving training images;
utilizing one or more AI models that each analyze the training images, wherein the one or more AI models include respective objective functions;
receiving, from the one or more AI models, the respective objective functions obtained after each of the one or more AI models are separately trained; and
submitting a combined weighted objective function to train the AI system, wherein the combined weighted objective function is a weighted combination of the respective objective function from each of the one or more AI models.

20. The computer program product of claim 19, wherein the one or more AI models comprise: classification AI criteria, wherein the classification AI criteria are used to classify whether a first image of the training images indicates that a user likely has cancer or that the user is likely cancer-free;
attention map AI criteria, wherein the attention map AI criteria are used to generate attention maps, wherein the attention maps are representations of areas of the training images that the classification AI criteria utilized to make a classification; and
localization AI criteria, wherein the localization AI criteria are used to localize objects of interest on the first image.
